(19) United States
(12) Patent Application Publication
(10) Pub. No.: US 2025/0316861 A1
(43) Pub. Date: Oct. 9, 2025

(54) Secondary Battery

(71) Applicant: TOYOTA BATTERY Co., Ltd., Kosai-shi (JP)

(72) Inventor: Tatsuya Yamamoto, Kosai-shi (JP)

(21) Appl. No.: 19/051,306

(22) Filed: Feb. 12, 2025

(30) Foreign Application Priority Data
Apr. 9, 2024 (JP) 2024-062888

(51) Int. Cl. H01M 50/538; H01M 10/04; H01M 10/0525; H01M 50/103; H01M 50/15; H01M 50/55

(52) U.S. Cl. CPC H01M 50/538; H01M 10/0431; H01M 10/0525; H01M 50/103; H01M 50/15; H01M 50/55

(57) ABSTRACT

A secondary battery includes electrode components and battery terminals, wherein the electrode components each include tab groups protruding from opposite ends, as viewed in a first direction, the tab group of each electrode component which is on a first side in the first direction differs in position in a second direction orthogonal to the thickness direction of the electrode components from the tab group of any other electrode component which is on the first side in the first direction, as viewed in a first direction, the tab group of each electrode component which is on a second side in the first direction differs in position in the second direction from the tab group of any other electrode component which is on the second side in the first direction, the battery terminals each include a member including electrode joint sections each bonded to a tab group positioned to be bondable thereto.

### CROSS-REFERENCE TO RELATED APPLICATION

This application claims priority to Japanese Patent Application No. 2024-062888 filed Apr. 9, 2024, the disclosure of which is hereby incorporated by reference in its entirety.

### BACKGROUND OF THE INVENTION

### Field of the Invention

The present invention relates to a secondary battery.

### Description of Related Art

Secondary batteries are used in an electric vehicle such as an electric automobile including a motor as a driving source. Secondary batteries conventionally include such components as an electrode component, a casing containing the electrode component, and a battery terminal attached to the casing and electrically connected to the electrode component. A secondary battery of this type may include two or more electrode components in the casing for a larger capacity, for example. Such a secondary battery may be produced by a method disclosed in Japanese Unexamined Patent Application Publication No. 2023-097821 (JP 2023-097821), for example.

JP 2023-097821 discloses a battery including a battery casing, an electrode component group of three electrode components in the battery casing, and positive and negative electrode terminals connected to the electrode components. Specifically, the battery is configured such that the positive electrode terminal includes a current collector disposed in the battery casing and electrically connected to the respective positive electrodes of the electrode components and that the negative electrode terminal includes a current collector disposed in the battery casing and electrically connected to the respective negative electrodes of the electrode components.

The battery disclosed in JP 2023-097821 includes positive and negative electrode terminals (that is, battery terminals) each including a current collector including a member as a first current collecting section and three members as second current collecting sections bonded to the first current collecting section and the electrode components. The battery is, in other words, configured such that each electrode component to be connected to the terminals requires a member as a second current collecting section. This means that the battery is configured such that the number of members as second current collecting sections varies according to the number of electrode components to be included. Increasing the number of electrode components to be included inevitably increases the number of parts of a battery terminal.

### SUMMARY OF THE INVENTION

The present invention has been accomplished in view of the above circumstances. The present invention has an object of providing a secondary battery including more electrode components without an increase in the number of parts to achieve a larger capacity.

To attain the above object, a secondary battery according to the present invention characteristically includes:
a housing with an opening;
a lid attached to the opening;
a plurality of flat electrode components each including:
   a positive electrode element;
   a negative electrode element; and
   a separator between the positive electrode element and the negative electrode element,
the positive electrode element, the negative electrode element, and the separator being on top of one another; and
two battery terminals each attached to the lid;
wherein the electrode components each include a tab group of a plurality of tabs of the positive electrode element which tabs are on top of one another and a tab group of a plurality of tabs of the negative electrode element which tabs are on top of one another,
the electrode components are contained in the housing and arranged in a thickness direction of the electrode components,
the tab groups protrude from respective opposite ends of the electrode component in a first direction orthogonal to the thickness direction,
as viewed in the first direction, that one of the tab groups of each of the electrode components which is on a first side in the first direction differs in position in a second direction orthogonal to the thickness direction from that one of the tab groups of any other of the electrode components which is on the first side in the first direction,
as viewed in the first direction, that one of the tab groups of each of the electrode components which is on a second side in the first direction differs in position in the second direction from that one of the tab groups of any other of the electrode components which is on the second side in the first direction,
the battery terminals each include a single member including a plurality of plate-shaped electrode joint sections,
the electrode joint sections of a first one of the battery terminals are so positioned as to be bondable to those tab groups of the electrode components which are on the first side in the first direction,
the electrode joint sections of a second one of the battery terminals are so positioned as to be bondable to those tab groups of the electrode components which are on the second side in the first direction, and
the electrode joint sections are each bonded at a joint portion to that tab group which is so positioned as to be bondable to the electrode joint section, the joint portion being so bent as to, as viewed in the first direction, coincide with an end face of a corresponding one of the electrode components in the first direction.

The above configuration allows two or more electrode joint sections of a single member to be each bonded to a tab of an electrode component, making it possible to include more electrode components without an increase in the number of parts. The above secondary battery thus includes more electrode components without an increase in the number of parts to achieve a larger capacity.

Those tab groups of each electrode component which are on the first side in the first direction differ in position in the second direction from the positionally corresponding electrode joint sections. Those tab groups of each electrode component which are on the second side in the first direction differ in position in the second direction from the positionally corresponding electrode joint sections. This allows the tab groups to be ultrasonically bonded to the respective electrode joint sections with use of a horn and an anvil.

The secondary battery may be further configured such that
that tab group of each of the electrode components which is on the first side in the first direction differs in position in the second direction from that tab group of said each of the electrode components which is on the second side in the first direction.

With the above configuration, each electrode component has a fixing axis not coinciding with the fixing axis of any other electrode component as viewed in the thickness direction of the electrode components. This allows each electrode component to prevent another electrode component from rotating about its fixing axis. The above secondary battery thereby prevents the electrode components from shaking.

The secondary battery may be further configured such that
the battery terminals each include thin portions that as viewed in the first direction, define respective areas including the electrode joint sections.

The above configuration allows each battery terminal to be easily divided along the thin portions into two or more segments, allowing the secondary battery to be disassembled efficiently.

The secondary battery may be further configured such that
as viewed in the first direction, the tab groups of each of the electrode components are each at a portion of said each of the electrode components which portion is central in the thickness direction.

The above configuration makes it easy to increase the number of tabs of the positive and negative electrode elements for tab groups. The increase in the number of tabs increases the number of conduction paths and shortens the overall conduction path of the electrode element, thereby allowing for production of a secondary battery with a reduced electric current loss.

### Advantageous Effects of Invention

As described above, the above secondary battery includes more electrode components without an increase in the number of parts to achieve a larger capacity.

### BRIEF DESCRIPTION OF THE DRAWINGS

FIG. 1 is an exploded perspective view of a secondary battery as an embodiment.

FIG. 2 is a schematic cross-sectional view of a secondary battery.

FIG. 3 is a perspective view of a partially developed electrode component.

FIG. 4 is a front view of an electrode component.

FIG. 5 is a front view of two electrode components and current collecting terminals before ultrasonic bonding, illustrating the positional relationship between the electrode components and the current collecting terminals.

FIG. 6 is a side view of two electrode components and current collecting terminals at the time of ultrasonic bonding, illustrating the positional relationship between the electrode components and the current collecting terminals.

FIG. 7 is a perspective view of two electrode components as assembled to current collecting terminals.

FIG. 8 is a perspective view of a current collecting terminal for an alternative embodiment.

FIG. 9 is a side view of the internal structure of the negative electrode of a secondary battery as an alternative embodiment.

### DESCRIPTION OF THE INVENTION

The description below deals with a secondary battery as an embodiment of the present invention with reference to drawings. The secondary battery described below is a lithium-ion secondary battery as an example. The description below and the drawings are simplified as appropriate for clarity.

### Outline of Secondary Battery 1

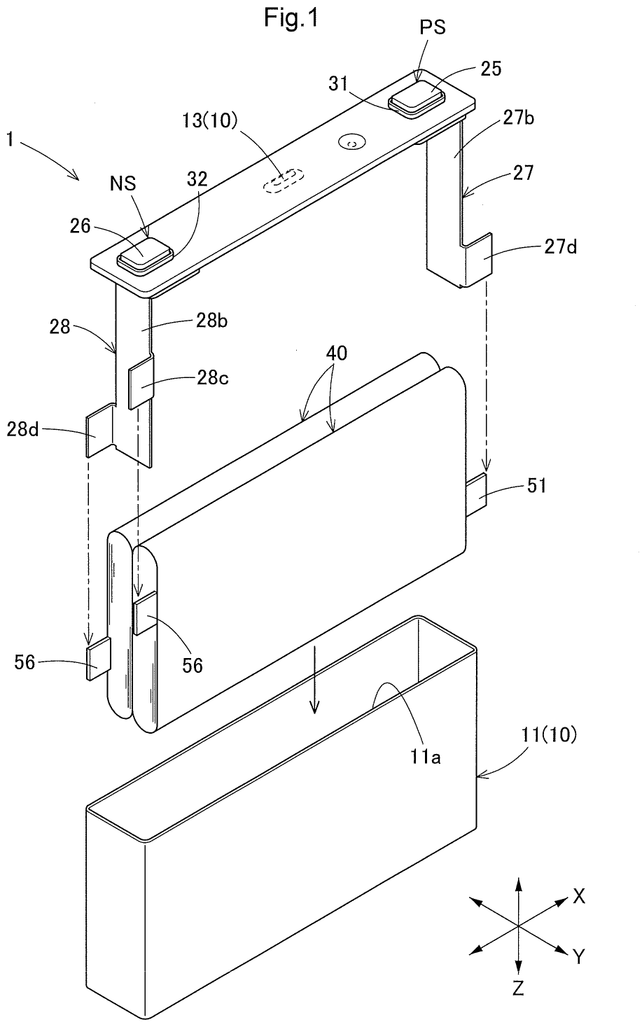

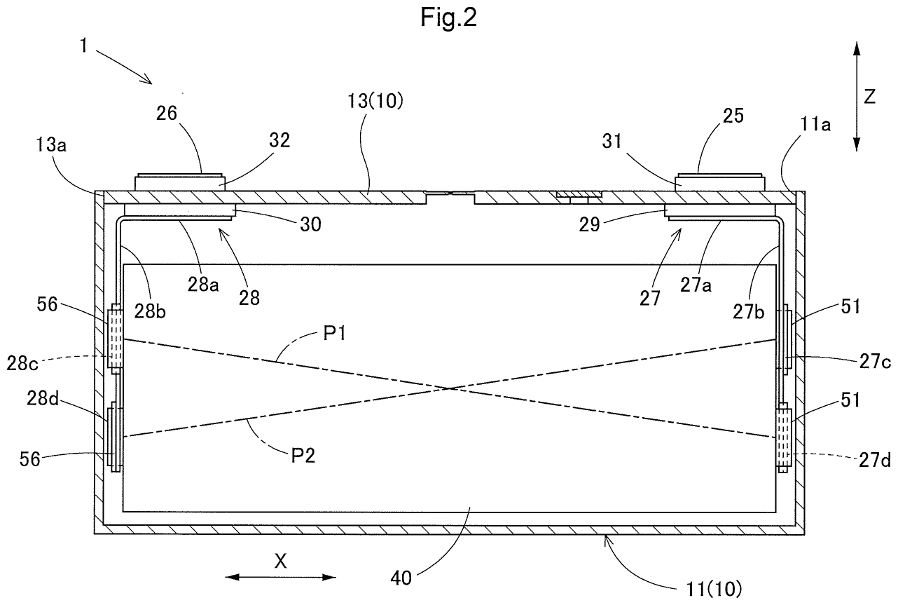

The description below outlines a secondary battery 1 as the present embodiment with reference to FIGS. 1 and 2. FIG. 1 is an exploded perspective view of the secondary battery 1. FIG. 2 is a schematic cross-sectional view of the secondary battery 1. The description below uses the expression “Z-axis direction” to refer to the direction along the height of the secondary battery 1, the expression “X-axis direction” to refer to the direction along the winding axis of each electrode component 40, and the expression “Y-axis direction” to refer to the direction along the thickness of each electrode component 40. The Z-axis direction is a vertical direction, whereas the X-axis and Y-axis directions are horizontal directions orthogonal to each other. The X-axis direction for the present embodiment corresponds to the “first direction” recited in the claims. The Z-axis direction for the present embodiment corresponds to the “second direction” recited in the claims.

As illustrated in FIGS. 1 and 2, the secondary battery 1 includes components such as (i) a battery casing 10 including a casing body 11 and a sealing plate 13, (ii) a battery terminal PS including an external terminal 25 and a current collecting terminal 27 and attached to the sealing plate 13, (iii) a battery terminal NS including an external terminal 26 and a current collecting terminal 28 and attached to the sealing plate 13, and (iv) two electrode components 40 and 40 each electrically connected to the current collecting terminals 27 and 28. The secondary battery 1 is a sealed one produced by containing in the casing body 11 components such as the electrode components 40 and the current collecting terminals 27 and 28, blocking the opening in the casing body 11 with the sealing plate 13, and injecting an electrolyte solution into the casing body 11.

### Battery Casing 10

As illustrated in FIGS. 1 and 2, the battery casing 10 for the present embodiment includes a casing body 11 in the shape of a substantial rectangular parallelepiped with an upward opening and a sealing plate 13 blocking the opening in the casing body 11. The battery casing 10 for the present embodiment is configured such that the casing body 11 and the sealing plate 13 are both made of aluminum. The material is, however, not limited to aluminum, and may alternatively be any of various metals or alloys. The casing body 11 for the present embodiment corresponds to the “housing” recited in the claims. The sealing plate 13 for the present embodiment corresponds to the “lid” recited in the claims.

The sealing plate 13 for the present embodiment corresponds in shape to the opening in the casing body 11 to block the opening. Specifically, the sealing plate 13 for the present embodiment is in the form of a flat plate substantially rectangular as viewed in the Z-axis direction. The sealing plate 13 has a first longitudinal end (that is, in the X-axis direction) provided with a positive electrode battery terminal PS and a second longitudinal end provided with a negative electrode battery terminal NS.

As detailed later, the present embodiment is configured such that the sealing plate 13 has an outer edge 13a laser-welded to an opening edge 11a of the casing body 11 for the sealing plate 13 to block the opening in the casing body 11.

### Electrode Components 40

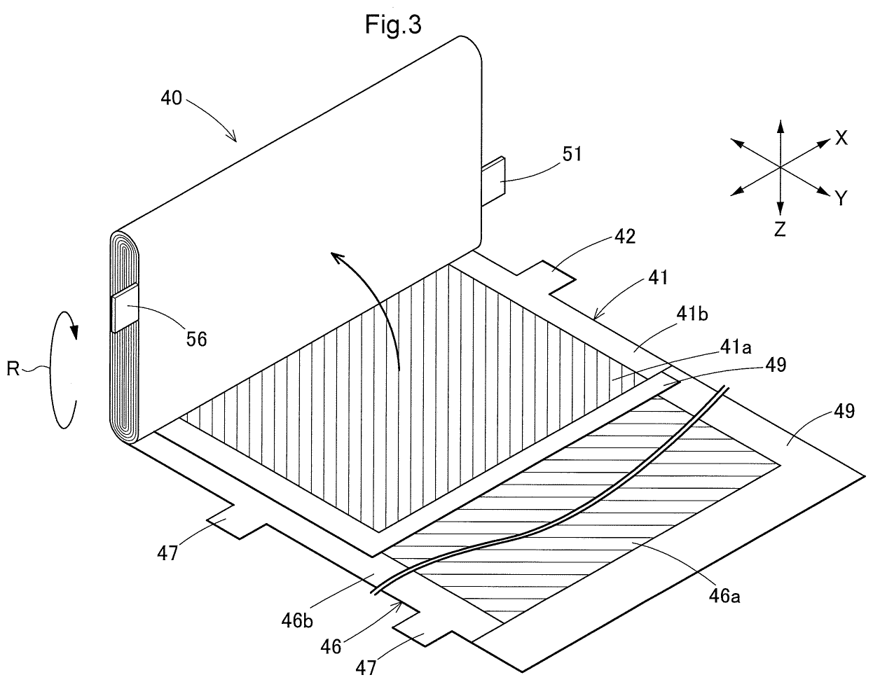

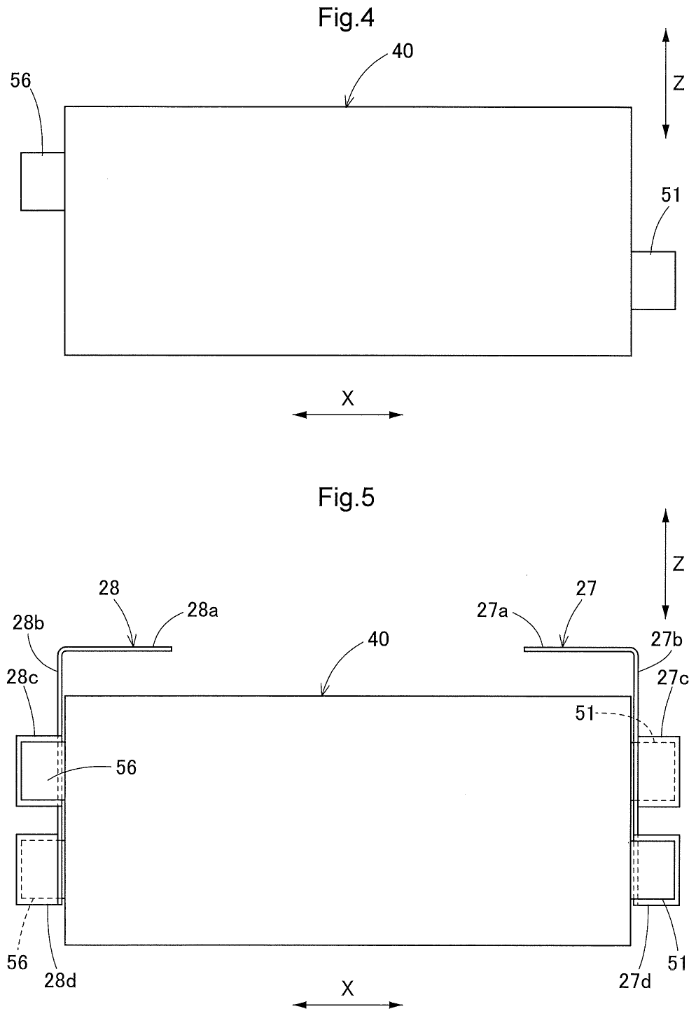

FIG. 3 is a perspective view of a partially developed electrode component 40. FIG. 4 is a front view of an electrode component 40. As illustrated in FIGS. 3 and 4, each electrode component 40 includes a long belt-shaped positive electrode element 41, a long belt-shaped negative electrode element 46, and a belt-shaped separator 49 therebetween. The three layers are disposed on top of one another, wound around, and compressed into a flat shape. The positive electrode element 41 for the present embodiment is in the form of an aluminum foil, whereas the negative electrode element 46 for the present embodiment is in the form of a copper foil.

The positive electrode element 41 includes (i) a positive electrode coated section 41a with each face coated with a positive electrode active material and (ii) at a first end in the X-axis direction, a positive electrode non-coated section 41b not coated with a positive electrode active material. The positive electrode element 41 includes two or more positive electrode tabs 42 protruding outward from the first end in the X-axis direction and spaced from one another such that the electrode component 40 as wound around includes a positive electrode tab group 51 below the center along its height.

The negative electrode element 46 includes (i) a negative electrode coated section 46a with each face coated with a negative electrode active material and (ii) at a second end in the X-axis direction, a negative electrode non-coated section 46b not coated with a negative electrode active material. The negative electrode element 46 includes two or more negative electrode tabs 47 protruding outward from the second end in the X-axis direction and spaced from one another such that the electrode component 40 as wound around includes a negative electrode tab group 56 above the center along its height.

The separator 49 is positioned to insulate the positive electrode coated section 41a from the negative electrode coated section 46a. The separator 49 may be made of an insulating material that allows ions to pass therethrough (for example, a porous insulating resin material).

The electrode component 40 includes a positive electrode tab group 51 protruding from a first end along the winding axis (that is, in the X-axis direction) and a negative electrode tab group 56 protruding from a second end along the winding axis. With the positive electrode element 41 and the negative electrode element 46 wound around, the positive electrode tabs 42 are on top of one another in layers as a positive electrode tab group 51, whereas the negative electrode tabs 47 are on top of one another in layers as a negative electrode tab group 56.

The positive electrode tab group 51 for the present embodiment protrudes along the winding axis from a portion of the first end of the electrode component 40 which portion is, as viewed along the winding axis (that is, in the X-axis direction), toward a first side along the thickness of the electrode component 40 (that is, in the Y-axis direction) and below the center along the height of the electrode component 40 (that is, in the Z-axis direction). The negative electrode tab group 56 for the present embodiment protrudes along the winding axis from a portion of the second end of the electrode component 40 which portion is, as viewed along the winding axis, toward the first side along the thickness of the electrode component 40 and above the center along the height of the electrode component 40. The positive electrode tab group 51 and the negative electrode tab group 56 are, as viewed along the thickness of the electrode component 40, each in the shape of a rectangle with long sides parallel to the height of the electrode component 40.

As described above, the electrode components 40 for the present embodiment each include a positive electrode tab group 51 protruding from a first end in the X-axis direction and a negative electrode tab group 56 protruding from a second end in the X-axis direction, the positive electrode tab group 51 and the negative electrode tab group 56 being positioned differently along the height of the electrode component 40.

The secondary battery 1 as the present embodiment includes in the casing body 11 two electrode components 40 arranged in the thickness direction (that is, in the Y-axis direction) with one of the electrode components 40 inverted upside down. The present embodiment is, in other words, configured such that as illustrated in FIG. 1, the respective positive electrode tab groups 51 of the electrode components 40 arranged in the thickness direction are positioned differently in the vertical, Z-axis direction and that the respective negative electrode tab groups 56 are also positioned differently in the vertical, Z-axis direction.

### Positive Electrode and Negative Electrode

The secondary battery 1 as the present embodiment includes a positive electrode including (i) a positive electrode battery terminal PS including a positive electrode external terminal 25 and a positive electrode current collecting terminal 27, (ii) a positive electrode insulator 29, and (iii) a positive electrode gasket 31. The secondary battery 1 as the present embodiment includes a negative electrode including (i) a negative electrode battery terminal NS including a negative electrode external terminal 26 and a negative electrode current collecting terminal 28, (ii) a negative electrode insulator 30, and (iii) a negative electrode gasket 32.

The secondary battery 1 as the present embodiment is configured such that the positive electrode external terminal 25 and the positive electrode current collecting terminal 27 are swaged into an integral battery terminal PS and that the negative electrode external terminal 26 and the negative electrode current collecting terminal 28 are swaged into an integral battery terminal NS (not detailed). The present embodiment is configured such that the positive electrode external terminal 25 and the positive electrode current collecting terminal 27 are each made of aluminum, whereas the negative electrode external terminal 26 and the negative electrode current collecting terminal 28 are made of aluminum and copper, respectively.

The present embodiment is configured as follows: The positive electrode gasket 31 insulates the positive electrode external terminal 25 from the sealing plate 13, whereas the negative electrode gasket 32 insulates the negative electrode external terminal 26 from the sealing plate 13. The positive electrode insulator 29 insulates the positive electrode current collecting terminal 27 from the sealing plate 13, whereas the negative electrode insulator 30 insulates the negative electrode current collecting terminal 28 from the sealing plate 13. The positive electrode insulator 29 and the positive electrode gasket 31 are between the positive electrode battery terminal PS and the sealing plate 13 for airtightness, whereas the negative electrode insulator 30 and the negative electrode gasket 32 are between the negative electrode battery terminal NS and the sealing plate 13 for airtightness. The present embodiment is configured such that the insulators 29 and 30 and the gaskets 31 and 32 are each made of perfluoroalkoxy alkane (PFA). The material is, however, not limited to PFA and may be any insulating material.

The present embodiment is configured as follows: The current collecting terminal 27 is in the form of a plate so bent as to include a base 27a swaged with the external terminal 25, a main section 27b continuous with the base 27a, a first electrode joint section 27c continuous with the main section 27b, and a second electrode joint section 27d continuous with the main section 27b. The current collecting terminal 28 is in the form of a plate so bent as to include a base 28a swaged with the external terminal 26, a main section 28b continuous with the base 28a, a first electrode joint section 28c continuous with the main section 28b, and a second electrode joint section 28d continuous with the main section 28b. This means that the current collecting terminal 27 as a single member includes two electrode joint sections 27c and 27d and that the current collecting terminal 28 as a single member includes two electrode joint sections 28c and 28d.

The present embodiment is configured as follows: The current collecting terminals 27 and 28 are each substantially rectangular as viewed in the Z-axis direction. The bases 27a and 28a are each oriented horizontally and each face the lower face of the sealing plate 13. The main sections 27b and 28b extend downward from the respective bases 27a and 28a in the Z-axis direction, are each substantially rectangular as viewed in the X-axis direction, and are each between the electrode components 40 and a side wall of the casing body 11.

The electrode joint sections 27c and 27d are so positioned as to be bondable to the respective tab groups 51 of the electrode components 40, whereas the electrode joint sections 28c and 28d are so positioned as to be bondable to the respective tab groups 56 of the electrode components 40. Specifically, the electrode joint sections 27c and 27d, before being assembled to the electrode components 40, extend in the X-axis direction from respective opposite edges of the main section 27b and are each substantially rectangular as viewed in the Y-axis direction. The first electrode joint section 27c is above the center in the Z-axis direction, whereas the second electrode joint section 27d is below the center in the Z-axis direction. The electrode joint sections 28c and 28d, before being assembled to the electrode components 40, extend in the X-axis direction from respective opposite edges of the main section 28b and are each substantially rectangular as viewed in the Y-axis direction. The first electrode joint section 28c is above the center in the Z-axis direction, whereas the second electrode joint section 28d is below the center in the Z-axis direction. The electrode joint sections 27c and 27d each have a face (joint face) outward in the Y-axis direction which face is bonded to a tab group 51. The electrode joint sections 28c and 28d each have a face (joint face) outward in the Y-axis direction which face is bonded to a tab group 56. As illustrated in FIGS. 2 and 7, the electrode joint sections 27c and 27d are each bonded to its corresponding tab group 51 at a portion so bent as to coincide with an end face of the electrode component 40 in the X-axis direction, whereas the electrode joint sections 28c and 28d are each bonded to its corresponding tab group 56 at a portion so bent as to coincide with an end face of the electrode component 40 in the X-axis direction (detailed later).

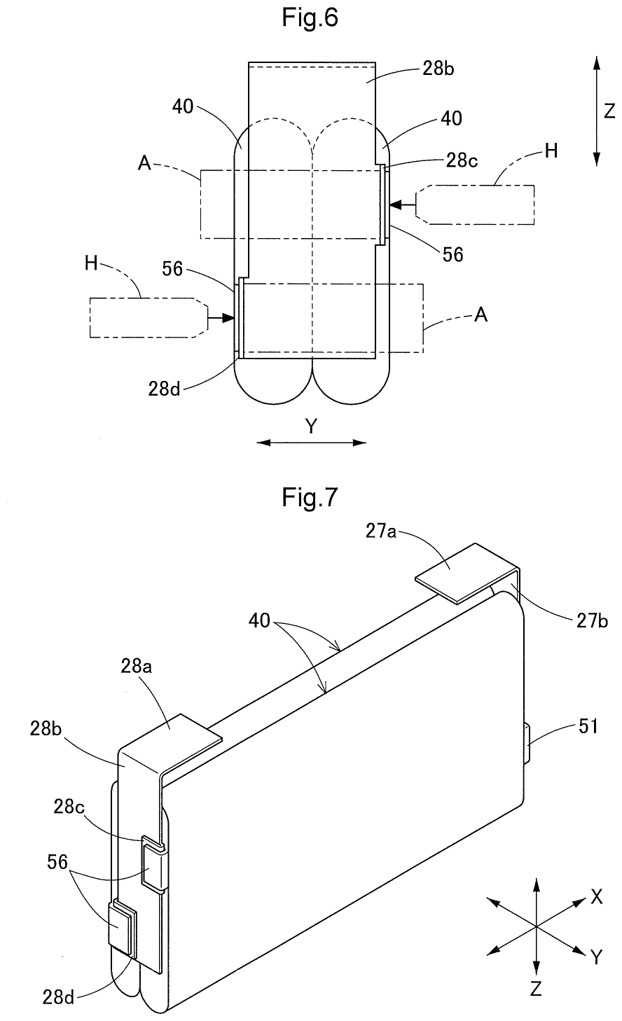

With reference to FIGS. 5 to 7, the description below deals with a method for assembling the electrode components 40 to the current collecting terminals 27 and 28. FIG. 5 is a front view of the electrode components 40 and the current collecting terminals 27 and 28 before ultrasonic bonding, illustrating the positional relationship between the electrode components 40 and the current collecting terminals 27 and 28. FIG. 6 is a side view of the electrode components 40 and the current collecting terminals 27 and 28 at the time of ultrasonic bonding, illustrating the positional relationship between the electrode components 40 and the current collecting terminals 27 and 28 on the negative electrode side. FIG. 7 is a perspective view of the electrode components 40 as assembled to the current collecting terminals 27 and 28. FIG. 7 omits such components as the sealing plate 13 and the external terminals 25 and 26.

As illustrated in FIG. 5, the method includes first placing the electrode components 40 on the current collecting terminals 27 and 28 attached to the sealing plate 13 in such a manner that the electrode joint sections 27c and 27d each face its corresponding tab group 51 in the Y-axis direction and that the electrode joint sections 28c and 28d each face its corresponding tab group 56 in the Y-axis direction. In other words, the method includes (i) placing the positive electrode current collecting terminal 27 in such a manner that the first electrode joint section 27d faces the positive electrode tab group 51 of a first one of the electrode components 40 and that the second electrode joint section 27c faces the positive electrode tab group 51 of a second one of the electrode components 40 and (ii) placing the negative electrode current collecting terminal 28 in such a manner that the first electrode joint section 28c faces the negative electrode tab group 56 of the first electrode components 40 and that the second electrode joint section 28d faces the negative electrode tab group 56 of the second electrode component 40.

The method includes then bonding the electrode joint sections 27c and 27d to the respective tab groups 51 and the electrode joint sections 28c and 28d to the respective tab groups 56. Specifically, the method includes (i) bringing each of the electrode joint sections 27c and 27d into contact with its corresponding tab group 51 at their mutually facing faces and each of the electrode joint sections 28c and 28d into contact with its corresponding tab group 56 at their mutually facing faces and (ii) ultrasonically bonding each of the electrode joint sections 27c and 27d to its corresponding tab group 51 and each of the electrode joint sections 28c and 28d to its corresponding tab group 56 with use of a horn H and an anvil A.

The secondary battery 1 as the present embodiment is configured such that the positive electrode tab group 51 of the first electrode component 40 and the electrode joint section 27d facing the tab group 51 are positioned differently in the vertical, Z-axis direction from the positive electrode tab group 51 of the second electrode component 40 and the electrode joint section 27c facing the tab group 51 and that the negative electrode tab group 56 of the first electrode component 40 and the electrode joint section 28c facing the tab group 56 are positioned differently in the vertical, Z-axis direction from the negative electrode tab group 56 of the second electrode component 40 and the electrode joint section 28d facing the tab group 56

The above configuration, as illustrated in FIG. 6, leaves a space on that side of, for example, each of the first and second electrode joint sections 28c and 28d which is opposite to the corresponding negative electrode tab group 56. The method thus includes placing an anvil A onto the first electrode joint section 28c, placing a horn H onto the negative electrode tab group 56 of the first electrode component 40 (that is, the upper right negative electrode tab group 56 in FIG. 6), pressurizing the horn H against the negative electrode tab group 56, and applying horizontal ultrasonic vibrations to the negative electrode tab group 56 with use of the horn H to bond the first electrode joint section 28c to the negative electrode tab group 56. The method also includes ultrasonic bonding with use of the horn H and the anvil A to similarly bond the second electrode joint section 28d to the negative electrode tab group 56 of the second electrode component 40. The above configuration leaves a space also on that side of each of the first and second electrode joint sections 27c and 27d which is opposite to the corresponding positive electrode tab group 51 (not illustrated in the drawings). This allows ultrasonic bonding with use of the horn H and the anvil A to bond each of the electrode joint sections 27c and 27d to its corresponding positive electrode tab group 51.

The method includes, with the electrode joint sections 27c and 27d bonded to the respective tab groups 51 and the electrode joint sections 28c and 28d bonded to the respective tab groups 56, bending each bonded portion in such a manner that the bonded portion coincides with an end face of the corresponding electrode component 40 in the X-axis direction. Specifically, the member includes (i) bending the electrode joint sections 27c and 27d in such a manner that each of the electrode joint sections 27c and 27d has a face opposite to the corresponding positive electrode tab group 51 which face is in contact with a side face of the main section 27b and (ii) bending the electrode joint sections 28c and 28d in such a manner that each of the electrode joint sections 28c and 28d has a face opposite to the corresponding negative electrode tab group 56 which face is in contact with a side face of the main section 28b. This assembles the electrode components 40 to the current collecting terminals 27 and 28 as illustrated in FIG. 7.

As described above, the secondary battery 1 as the present embodiment includes a current collecting terminal 27 as a single member with electrode joint sections 27c and 27d bonded to respective tab groups 51 of two electrode components 40 and a current collecting terminal 28 as a single member with electrode joint sections 28c and 28d bonded to respective tab groups 56 of the electrode components 40. The secondary battery 1 thus includes more electrode components 40 without an increase in the number of parts for a larger capacity.

The secondary battery 1 as the present embodiment is configured as follows: Each electrode component 40 includes a positive electrode tab group 51 and a negative electrode tab group 56 positioned differently from each other in the Z-axis direction. The electrode joint sections 27c and 27d are each bonded to its corresponding positive electrode tab group 51, whereas the electrode joint sections 28c and 28d are each bonded to its corresponding negative electrode tab group 56, so that the electrode components 40 are fixed. In other words, as illustrated in FIG. 2, the first electrode component 40 has a fixing axis P1 extending obliquely upward from its positive electrode tab group 51 to its negative electrode tab group 56 as viewed in the Y-axis direction, whereas the second electrode component 40 has a fixing axis P2 extending obliquely downward from its positive electrode tab group 51 to its negative electrode tab group 56 as viewed in the Y-axis direction. Stated differently, the fixing axes P1 and P2 of the respective electrode components 40 each extend obliquely relative to the X-axis direction between the positive electrode tab group 51 and the negative electrode tab group 56 such that the fixing axes P1 and P2 cross each other. This allows each electrode component 40 to prevent the other electrode component 40 from rotating about its fixing axis. The secondary battery 1 as the present embodiment thereby prevents the electrode components 40 from shaking. The positive electrode tab group 51 of each electrode component 40 for the present embodiment corresponds to the tab group on the first side in the first direction recited in the claims, whereas the negative electrode tab group 56 of each electrode component 40 for the present embodiment corresponds to the tab group on the second side in the first direction recited in the claims.

### Alternative Embodiments

(1) The embodiment described above under “Description of Embodiments” is configured such that the electrode joint sections 27c and 27d of the current collecting terminal 27 extend in the X-axis direction from respective opposite edges of the main section 27b and that the electrode joint sections 28c and 28d of the current collecting terminal 28 extend in the X-axis direction from respective opposite edges of the main section 28b. The present invention is, however, not limited to such a configuration. The current collecting terminals may each have any shape as long as the current collecting terminals each have two or more electrode joint sections.

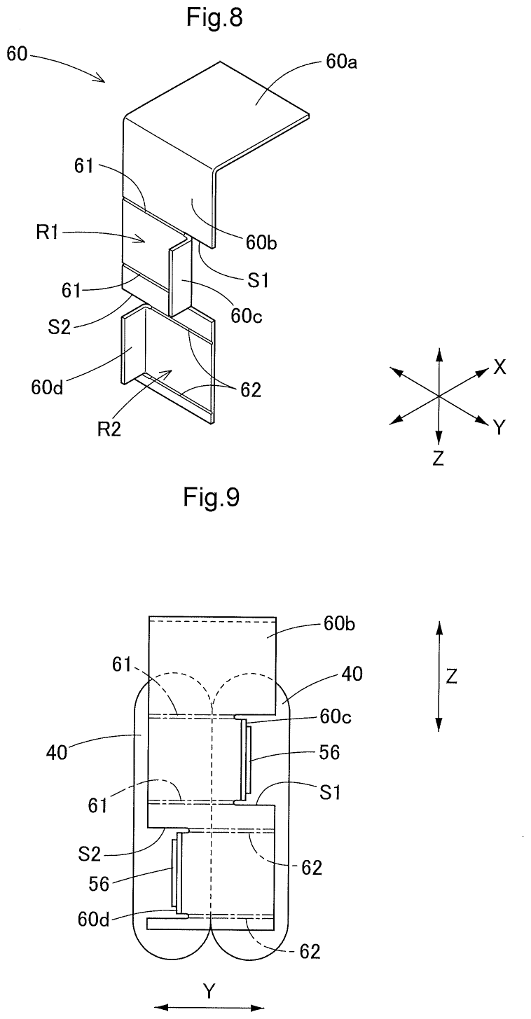

The current collecting terminals may each be shaped, for instance, as illustrated in FIG. 8, which is a perspective view of a current collecting terminal 60 for an alternative embodiment. The current collecting terminal 60 includes a base 60a, a main section 60b continuous with the base 60a, a first electrode joint section 60c, and a second electrode joint section 60d. The first electrode joint section 60c is formed by bending a portion of the main section 60b outward which portion is between a pair of slits S1 each extending from a first edge of the main section 60b. The second electrode joint section 60d is formed by bending a portion of the main section 60b outward which portion is between a pair of slits S2 each extending from a second edge of the main section 60b.

The current collecting terminal 60 includes thin portions 61 that as viewed in the X-axis direction, define an area R1 including the first electrode joint section 60c and thin portions 62 that as viewed in the X-axis direction, define an area R2 including the second electrode joint section 60d. Specifically, the thin portions 61 are each in the form of a groove extending from the terminal end of a slit S1 to an edge of the main section 60b, whereas the thin portions 62 are each in the form of a groove extending from the terminal end of a slit S2 to an edge of the main section 60b.

The current collecting terminal 60 also allows the secondary battery 1 to include more electrode components 40 without an increase in the number of parts for a larger capacity. The electrode joint sections 60c and 60d are ultrasonically bondable to respective tab groups 51 or 56 with use of a horn H and an anvil A. Further, dividing the current collecting terminal 60 along the thin portions 61 and 62 allows the current collecting terminal 60 to be easily separated from the electrode components 40. The current collecting terminal 60 allows the secondary battery to be disassembled efficiently.

(2) The embodiment described above under “Description of Embodiments” is configured such that the tab groups 51 and 56 each protrude from a portion of an end of the electrode component 40 which portion is, as viewed along the winding axis (that is, in the X-axis direction), toward one side along the thickness of the electrode component 40 (that is, in the Y-axis direction). The present invention is, however, not limited to such a configuration. FIG. 9 is a side view of the internal structure of the negative electrode of a secondary battery as an alternative embodiment. For instance, the negative electrode tab groups 56 may, as illustrated in FIG. 9, each extend from a portion of an end of the electrode component 40 which portion is, as viewed along the winding axis (that is, in the X-axis direction), central along the thickness of the electrode component 40 (that is, in the Y-axis direction). This allows the negative electrode element 46 to include more negative electrode tabs 47 for the negative electrode tab group 56. The increase in the number of tabs increases the number of conduction paths and shortens the overall conduction path of the electrode element, thereby allowing for production of a secondary battery with a reduced electric current loss. The positive electrode tab groups 51 may similarly each extend from a portion of an end of the electrode component 40 which portion is, as viewed along the winding axis (that is, in the X-axis direction), central along the thickness of the electrode component 40 (that is, in the Y-axis direction).

With the tab groups each extending from a portion of an end of the electrode component which portion is, as viewed along the winding axis (that is, in the X-axis direction), central along the thickness of the electrode component (that is, in the Y-axis direction), the secondary battery should preferably include current collecting terminals 60 rather than current collecting terminals 27 and 28. The current collecting terminals 27 and 28 are configured such that the electrode joint sections 27c and 27d extend in the X-axis direction from respective opposite edges of the main section 27b and that the electrode joint sections 28c and 28d extend in the X-axis direction from respective opposite edges of the main section 28b. This requires the current collecting terminals 27 and 28 to each have a small main section 27b or 28b, with the result of a narrow conduction path. The current collecting terminals 60 may, in contrast, each have a relatively large main section 60b as compared to the current collecting terminals 27 and 28, with the result of a wide conduction path.

(3) The embodiment described above under “Description of Embodiments” is configured such that the secondary battery includes two electrode components 40. The present invention is, however, not limited to such a configuration. The secondary battery may include three or more electrode components. The secondary battery, in this case, includes current collecting terminals each with more electrode joint sections in correspondence with the number of electrode components to include more electrode components without an increase in the number of parts.

(4) The embodiment described above under “Description of Embodiments” is configured such that each electrode component 40 includes a positive electrode tab group 51 and a negative electrode tab group 56 positioned differently from each other in the Z-axis direction. The present invention is, however, not limited to such a configuration. Each electrode component may include a positive electrode tab group and a negative electrode tab group at the same position in the Z-axis direction. The secondary battery may, for instance, include two electrode components as described under “Description of Embodiments”, a first one of the electrode components including a positive electrode tab group and a negative electrode tab group above the center in the Z-axis direction, a second one of the electrode components including a positive electrode tab group and a negative electrode tab group below the center in the Z-axis direction. The electrode components are, in this case as well, arranged in the thickness direction such that the respective positive electrode tab groups are positioned differently in the Z-axis direction and that the respective negative electrode tab groups are positioned differently in the Z-axis direction.

(5) The embodiment described above under “Description of Embodiments” is configured such that the electrode components 40 are wound around. The present invention is, however, not limited to such a configuration. The electrode components may each have any structure as long as the electrode components each include a positive electrode tab group and a negative electrode tab group. The electrode components may each be structured as any of various common sealed secondary batteries.

The arrangements of each of the embodiments described above (including the alternative embodiments) may be used in combination with an arrangement(s) disclosed for a different embodiment unless such combination causes any contradiction. The embodiments disclosed herein (including the alternative embodiments) are merely examples. The present invention is not limited to such embodiments, and may be varied as appropriate as long as such variation does not prevent an object of the present invention from being attained.

### REFERENCE SIGNS LIST

1 Secondary battery
11 Casing body (housing)
13 Sealing plate (lid)
40 Electrode component
41 Positive electrode element
42 Positive electrode tab
46 Negative electrode element
47 Negative electrode tab
49 Separator
51 Positive electrode tab group
56 Negative electrode tab group
PS Positive electrode battery terminal (battery terminal)
NS Negative electrode battery terminal (battery terminal)
27, 28 Current collecting terminal
27c, 28c First electrode joint section (one of electrode joint sections)
27d, 28d Second electrode joint section (one of electrode joint sections)

1. A secondary battery, comprising:
a housing with an opening;
a lid attached to the opening;
a plurality of flat electrode components each comprising:
a positive electrode element;
a negative electrode element; and
a separator between the positive electrode element and the negative electrode element, and
wherein:
the positive electrode element, the negative electrode element, and the separator are on top of one another;
two battery terminals are each attached to the lid;
wherein the electrode components each comprise a tab group of a plurality of tabs of the positive electrode element which tabs are on top of one another and a tab group of a plurality of tabs of the negative electrode element which tabs are on top of one another,
the electrode components are contained in the housing and arranged in a thickness direction of the electrode components,
the tab groups protrude from respective opposite ends of the electrode component in a first direction orthogonal to the thickness direction,
as viewed in the first direction, one of the tab groups of each of the electrode components which is on a first side in the first direction differs in position in a second direction orthogonal to the thickness direction from the one of the tab groups of any other of the electrode components which is on the first side in the first direction,
as viewed in the first direction, the one of the tab groups of each of the electrode components which is on a second side in the first direction differs in position in the second direction from the one of the tab groups of any other of the electrode components which is on the second side in the first direction,
the battery terminals each comprise a single member comprising a plurality of plate-shaped electrode joint sections,
the electrode joint sections of a first one of the battery terminals are so positioned as to be bondable to those tab groups of the electrode components which are on the first side in the first direction,
the electrode joint sections of a second one of the battery terminals are so positioned as to be bondable to those tab groups of the electrode components which are on the second side in the first direction, and
the electrode joint sections are each bonded at a joint portion to the tab group which is so positioned as to be bondable to the electrode joint section, the joint portion being so bent as to, as viewed in the first direction, coincide with an end face of a corresponding one of the electrode components in the first direction.

2. The secondary battery according to claim 1, wherein:
the tab group of each of the electrode components which is on the first side in the first direction differs in position in the second direction from the tab group of said each of the electrode components which is on the second side in the first direction.

3. The secondary battery according to claim 1, wherein:
the battery terminals each comprise thin portions, as viewed in the first direction, define respective areas including the electrode joint sections.

4. The secondary battery according to any one of claim 1, wherein:
as viewed in the first direction, the tab groups of each of the electrode components are each at a portion of said each of the electrode components which portion is central in the thickness direction.
